(19) United States
(12) Patent Application Publication
(10) Pub. No.: US 2025/0168438 A1
(43) Pub. Date: May 22, 2025

(54) COMPUTER SYSTEM FOR OPERATING CUSTOMIZED TELEVISION STREAMING SERVICE

(71) Applicant: Michael Covington, Noblesville, IN (US)

(72) Inventor: Michael Covington, Noblesville, IN (US)

(21) Appl. No.: 18/956,992

(22) Filed: Nov. 22, 2024

Related U.S. Application Data
(60) Provisional application No. 63/602,085, filed on Nov. 22, 2023.

(51) Int. Cl. H04N 21/2668; H04N 21/2543; H04N 21/442

(52) U.S. Cl. CPC H04N 21/2668; H04N 21/2543; H04N 21/44213

(57) ABSTRACT

A method for managing streaming services using a computer system comprising one or more computers connected with each other through a global communication network is provided. A project manager and a client each include a computer system. The method includes steps of tasking the project manager with creating a streaming channel for the client and channeling content received by the client through the project manager to a digital distribution service for streaming to an end viewer. The method also includes channeling content received by at least one content provider other than the client through the project manager to the digital distribution service for streaming to the end viewer. The streamed content is viewed via the streaming channel by an end viewer.

### CROSS-REFERENCE TO RELATED APPLICATIONS

This application claims the priority of U.S. Provisional Patent Application No. 63/602,085 filed Nov. 22, 2023.

### TECHNICAL FIELD OF THE INVENTION

The present invention relates to computer systems, and more particularly, to a computer system configured for operating a multifaceted, multicomponent organization for producing, distributing, and broadcasting television content through a global computer network.

### BACKGROUND

Institutions and corporations, such as educational institutions, government agencies, and businesses are often in need of undertaking actions to promote their mission and increase revenue streams. For purposes of this application, these institutions, agencies and businesses shall be referred to as “enterprises”.

One thing that these enterprises often do to achieve these goals is to find ways to raise their profile, so that these enterprises become better known to the public and hopefully, better known to the public in a way that enhances the reputation of the enterprise among the public. Additionally, these enterprises need to engage in activities to help enhance their revenue streams. For a business type institution, enhancing the revenue stream might comprise increasing both the volume of your sales, and the profitability of your sales.

For a non-profit institution, the increased revenue stream may come in the form of increasing the number of patients or persons that are served in a healthcare or human services agency or increasing the number of students who choose to attend an educational institution, for educational enterprises. Additionally, with educational enterprises, it is incumbent for the enterprise to increase the degree of affinity that persons have for the institution, such as alumni and grant makers who give money to the institution, students who seek out the institution to attend, faculty members who become more favorably disposed to teach at the institution, and thereby increase the perceived desirability of teaching at the institution, and also increase the affinity of the general public.

With many educational institutions, the affinity of the general public with the educational institution is often fostered by athletic teams that the general public follows, which causes the persons in the general public to purchase tickets for events, watch sporting and other events on television, buy branded merchandise, and encourage other persons within their orbit to attend the educational institutions as students.

Prior to the introduction of cable tv, the number of broadcast outlets in a particular area was limited to those outlets that could obtain ownership, or exclusive use of a frequency, such as “Channel 12” in a particular area. However, the introduction of cable tv greatly expanded the number of channels for which information and programming could be conveyed to the public.

More recently the widespread use of a global computer network, such as the internet, when coupled to widely available broadband streaming, has exponentially expanded the number of potential “channels” of information, such as television programming that can be distributed to consumers.

One object of the present invention is to provide a computer based system and method, for enabling enterprises, and especially educational enterprises, to be able to establish their own “channel” of streaming information to better help the enterprise raise its awareness among the public, and potentially, increase its revenue stream, and hopefully, its profitability.

### SUMMARY OF THE INVENTION

In accordance with the present invention, a connected computer system is provided that includes one or more computers in communication with each other through a global communication network. The computers and network, collectively are provided and configured for communicating with a client, such as an enterprise, and a project manager, wherein the project manager is tasked with establishing a streaming channel for the enterprise client. The computer system of the project manager is in communication with providers that are necessary for the creation of the streaming output content, including providers such as finance providers, content providers, advertising providers, and editors.

Additionally, the computer system is configured to provide communication between the project manager and the enterprise, to enable the project manager to obtain content from the enterprise. Further, the computer system of the project manager is in communication with one or more outlets, through which content that is obtained or created by the project manager can be delivered to the end viewer.

Preferably, these output channels include an over-the-top (OTT) platform, or digital distribution service, for delivering streamed content over the global computer network, via a channel, and the global computer network to deliver the streamed content from the OTT platform to a viewer.

One feature of the present invention is that the content that it is created and the content that is delivered can be content that is customized to fit the needs of the client (e.g., educational institution), and can be delivered to the viewer via a variety of protocols and configurations, including Free Advertising Supported Television (FAST); Authenticated Video On Demand (AUTHVOD); Advertising-Based Video On Demand (AVOD); Subscription Video On Demand (SVOD); and Transactional Video On Demand (TVOD).

These and other features will become apparent to those skilled in the art upon a review of the detailed description and drawings presented below.

### IV. BRIEF DESCRIPTION OF THE DRAWINGS

FIG. 1 is a schematic representation to illustrate the various parties connected by the computer system of the present invention, and their relation to each other;

FIG. 2 is a schematic relationship of the content creation and dissemination aspect of the present invention;

FIG. 3 is a schematic representation of an interface relationship between the user and the OTT platform;

FIG. 4 is a schematic representation of a relationship between the project manager, client, content creators, content distributors, and the end user;

FIG. 5 is a schematic representation that illustrates the revenue streams flowing between the various parties; and

FIG. 6 is a schematic representation of various licenses and rights bundles that exist between the parties.

### V. DETAILED DESCRIPTION OF PREFERRED EMBODIMENT

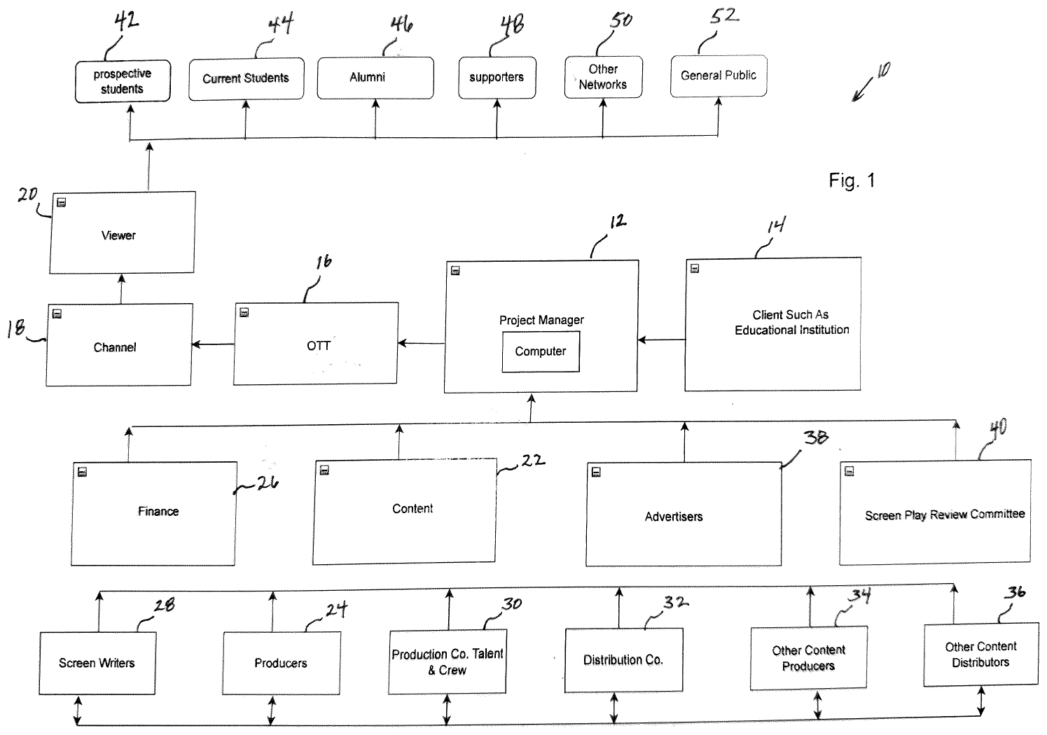

Turning now to the drawings, the invention will be described. Turning first to FIG. 1, a schematic representation is shown of the various parties who provide input of the sources, such as finance, content, advertising and the like to the project manager, who serves the client, and output sources who receive the output created and organized by the project manager and delivers the output to viewers.

The project manager is shown as having a computer. However, it will also be appreciated that although a computer is not explicitly shown with some of the other providers of content, and the outlet sources, that each of the resource providers and outlet handlers have computers.

Relationship lines are shown with arrows, which are also representative of communication paths between the various entities. Except for inhouse-entities which are contained on a private network, most of the communication between the various parties is conducted over a global computer network, such as an internet. Additionally, data may be stored locally or on the cloud, and other computer related devices, such as cloud-based servers, cloud- based storage, routers, communication lines such as fiber optic lines, processors and the like are provided to ensure that the various providers can perform their functions, and communicate with each other, along with delivering materials as necessary between the parties.

Turning first to FIG. 1, the central hub within the system 10 is the project manager 12. The project manager 12 contracts with a client 14, such as an educational institution, to create, produce, and distribute audio visual material, such as television programs and the like. The content so created is delivered to an OTT 16, which is a platform designed for distributing streaming services online over the internet. The OTT 16 creates one or more channels 18 that are specific to and customized for the client 14. The channel 18 then is distributed to a viewer 20. The OTT 16 preferably has the ability to distribute content 22 via a variety of methods, such as video-on-demand, live event broadcast streaming, and the distribution of FAST channels. According to one embodiment, the project manager 12 will receive content 22 from the content producers 24 and make it available in an “on demand” basis to subscribers of the channel. Additionally, the OTT 16 will do live broadcast event streaming, and will do content scheduled broadcast via the OTT Electronic Program Guide (EPG).

With regard to FAST channels, the project manager 12 will create one or more FAST Channels for the client 14. The FAST Channels will normally only operate within an EPG of an OTT platform 16. The project manager 12 will then present all relevant OTT platforms 16 with the opportunity to broadcast the client's FAST channel within their EPG. For example, the client's FAST channel would likely be presented to the following currently existing OTT platforms for inclusion into their EPG's:
a. Amazon Fire TV;
b. Samsung;
c. YouTube TV;
d. Roku;
e. Vizio;
f. Hulu
g. LG; and
h. Others.

Further, the project manager should also present the client's FAST channel to traditional linear cable providers, such as Comcast cable, Fox cable, ATT, Spectrum, Xfinity, and VIASAT.

The upstream portion of the project manager's world includes various resource providers who provide resources to the project manager 12, so that the project manager 12 can then organize and perform necessary steps, to achieve a finished product. Although the resource providers, such as the finance resource provider 26 and the content resource provider 22 are shown as being separate from the project manager 12, it will be appreciated that the finance and the content can be created inhouse by the project manager 12, rather than being outsourced. Additionally, the project manager 12 may choose to create an affiliate that performs one or more of the resource providing functions.

The primary resource providers include the finance provider 26. The finance provider 26 is necessary to provide financing, so that various creators, distributors, and owners of the streamed content 22 can be paid for their work or their products.

Several finance entities exist, including Venture Capital, Traditional Bank Financing, and through the sale of investment vehicles to investors who provide the financing.

Probably the most important provider is the content resource provider 22. As those familiar with the production of audio-visual productions such as television shows will appreciate, a wide variety of persons with a variety of talents need to be employed in order to create acceptable content. The content provider 22 then will work with either sub-contractors, or inhouse persons to provide the various elements of the content necessary. These content sub-providers include entities such as screen writers 28, to write the scripts for the various content, and producers 24 who help to produce the content, and production company talent and crew 30 to create the content.

Additionally, production companies are a content provider. As used in this application, the production company is either the single company or the plurality of companies and individuals that provide things such as the equipment such as cameras and sets, the crew, such as key grips, best boys camera operators, various assistants, security and the like. The production company is also being assumed in this application to coordinate the talent, such as actors and actresses who appear in productions.

Another content provider is a distribution company 32. A distribution company 32 typically works with content creators to distribute their product. The distribution company 32 will generally provide already existing content to the primary content provider. Further, other content producers 34 exist, who may, for example, be independent production companies, students and the like, along with other content distributors 36. The foregoing describes a group of persons and entities who are used to create content, and work with either the project manager directly, or a separate content providing general contractor type entity to provide content to the project manager which can then be delivered to the output sources.

A third input resource is the advertisers 38. The advertisers 38 include those persons who advertise on the channel 18, and likely include a variety of businesses, institutions and the like, of the type that might advertise on any other advertising supported television channel. As one might expect, the particular advertisers chosen and who are likely to advertise on the channel 18 are those advertisers that believe that the output content is viewed by the demographic that fits the advertisers' target viewing audience.

For example, an educational institution such as a college based in Colorado would likely draw its advertisers from businesses in Colorado who are well acquainted by the Colorado educational institution, and by persons who might be interested in the content being broadcast on the channel. For example, a Colorado Educational Institution would likely draw advertisements from Colorado related businesses, such as insurance companies and car dealers for its sports programming, since a large part of the relevant audience for a university sports program can be expected to be persons who live in the same area, or the same state as the educational institution.

On the other hand, insurance companies that sell policies in New England would probably not wish to advertise on the channel that supported an educational college in Colorado, such as the University of Colorado or Colorado State University.

Some advertisers may be attracted to advertising on the channel because of the subject matter being broadcast by one or more programs, which may be attractive to persons with subject matter interest, rather than a geographically related interest. For example, a show produced for a Kansas educational institution that dealt with advances in petroleum refining techniques, would likely draw advertisers who were interested in reaching those in the petroleum refining industry, which would likely include persons not only in Kansas, but others throughout oil producing regions, such as Texas, Louisianna, the Middle East, Canada, the North Sea, California, Venezuela, and Russia.

As will be discussed in more detail below, the relation between the project manager and the advertisers is often a two-way relationship, where the project manager solicits advertisers to purchase advertising, and the advertisers provide advertising content and revenue to the project manager.

Another input source is a review committee, such as a screen play review committee 40. In order for the channel to be successful, the content that is produced will need to be interesting to viewers, relevant to viewers, and not objectionable to viewers. Therefore, the project manager 12, either externally, or internally within organizations, should establish a project review committee.

The committee 40 should be charged to review projects, to determine which projects should be financed and moved forward, and also to review projects that are purchased or created for the project manager 12, to ensure that the projects represent interesting and well received content, of a type that is likely to be sought out by the target demographic viewers for the material, and which is not likely to be viewed as offensive by the viewers.

Once the content 22 is created by the project manager 12, the content 22 is output to the OTT platform 16, which is the platform that creates the streaming channel 18. The streaming channel 18 is then transmitted to the viewer 20, usually over a global computer network such as the internet, although some situations exist wherein the channel 18 can be broadcast over traditional airwaves.

However, one benefit of using a streaming platform is that unlike over the air broadcast, streaming services are not geographically limited. For a typical institutional educational client, such as a large university, the potential audience is usually very geographically diverse.

As a matter of policy, many schools seek to attract students who are from areas other than the geographic area in which the particular educational institution is located. Additionally, alumni and other supporters may be dispersed geographically throughout the country, and, depending on the university, throughout the world.

Further, funding sources such as private foundations, government agencies, and industrial supporters are dispersed over a wide geographic area. Therefore, the ability of a streaming channel to reach these diverse geographic areas is highly valuable to the educational institution.

For an educational enterprise client, such as a university or college, there are several different groups of target viewers that the university would seek to reach. One target group is prospective students 42.

A person looking to become a student at a university, can learn much about the university through watching the channel 18. By watching the channel 18, the prospective student 42 can become more familiar with the university and get a better “feeling” for what life would be like at the university, and the programs that the university has to offer.

Most educational institutions are constantly searching to find prospective students 42, for a variety of reasons. Some reasons are primarily financial, as student tuition helps to support a large part of the university budget. Additionally, the more prospective students apply to a university, the more selective the university can become about the students it accepts.

In the minds of the consuming public, a definite relationship has been established between the selectivity of a university and its perception as a quality university. For example, the acceptance rate of Ivy League colleges, which are generally perceived to be some of the highest quality colleges in the country, are typically in the 5% to 11% range, with Harvard University having a 4.5% acceptance rate, and Princeton and Yale having 5.9% acceptance rates.

At the other end of spectrum, community colleges often have acceptance rates of close to 100%. Because they admit almost everyone, they are generally perceived as not being as prestigious and desirable as the more selective colleges such as the Ivy League colleges.

Therefore, by increasing its visibility to perspective students by using the university dedicated channel of the present invention, the university has the capability of attracting a greater number of applications, which means that it can be more selective about the candidates it accepts for admissions into the university, which, over time, can cause the university to be perceived as more prestigious.

It is common knowledge that the prestige, or lack of prestige associated with the institution a person attended has a great bearing on how persons hiring graduates perceive the graduate. In this regard, it may not be an exaggeration to suggest that the person in the bottom 10% of his graduating class at Harvard or Yale is likely to get more offers than someone graduating in the top 10% of their class at an open admission community college.

Another target audience are current students 44. For current students 44, the streaming channel 18 can be used as a vehicle for providing information for current students, of an academic, social, and recreational nature.

For example, programming directed to current students 44 can provide academic subject matter, such as tutorials relating to various subjects. Social subject matters such as programs directed to events on campus, and campus resources, such as mental health counseling and the like can be provided. Additionally, recreational programming, such as television programming relating to things such as sporting events, campus theatrical events and musical performances can be provided to current students. This type of programming can likely help a school's student retention rate which is another metric that is used to evaluate a school's performance, and hence its desirability to students, faculty, and donors.

A third target group are alumni 46. By providing programming to alumni 46, the educational institution helps to keep alumni 46 connected with the school. By providing good programming, the educational institution can attract alumni 46 to watch programming relating to the educational institution that they otherwise would not view. Keeping the alumni 46 connected with the educational institution, helps to increase alumni support, donations, and gifts, along with helping to make the alumni 46 feel as though they are a part of the educational institution, which will hopefully motivate alumni 46 to recommend perspective students, including their own children to study at the university.

Another target market are university supporters 48, who may not be alumni 46. These supporters 48 include persons in positions to lend support to the university, such as granting agencies, foundations, and other persons who have an affinity with the university. A good example of such persons are fans of Notre Dame Football which, because of the popularity of Notre Dame Football, is not restricted to those with a direct connection to Notre Dame, such as students and alumni. Rather, Notre Dame football fans encompass a large group of persons, including devotees of college football, who have no relation or other connection to the educational institution such as Notre Dame.

Another target market might be other broadcasting networks 50. Attention by these networks could prove valuable to the university, as these networks might wish to buy the content created for the university channel, for rebroadcast on their network. For example, one could imagine a well-developed student created program directed to a historic figure, such as Kurt Vonnegut, may be picked up and broadcast by another network, such as the History Channel, NPR, or The Learning Channel which provides documentary related programming.

The third target demographic might be the general public 52, who might be interested in particular items of content that are created for the streaming channel. It is likely that the general public 52 would be most likely to be interested in the broadcast of the university sporting events, such as basketball games, football games, and the like, along with theatrical productions such as plays, operas, and musical concerts.

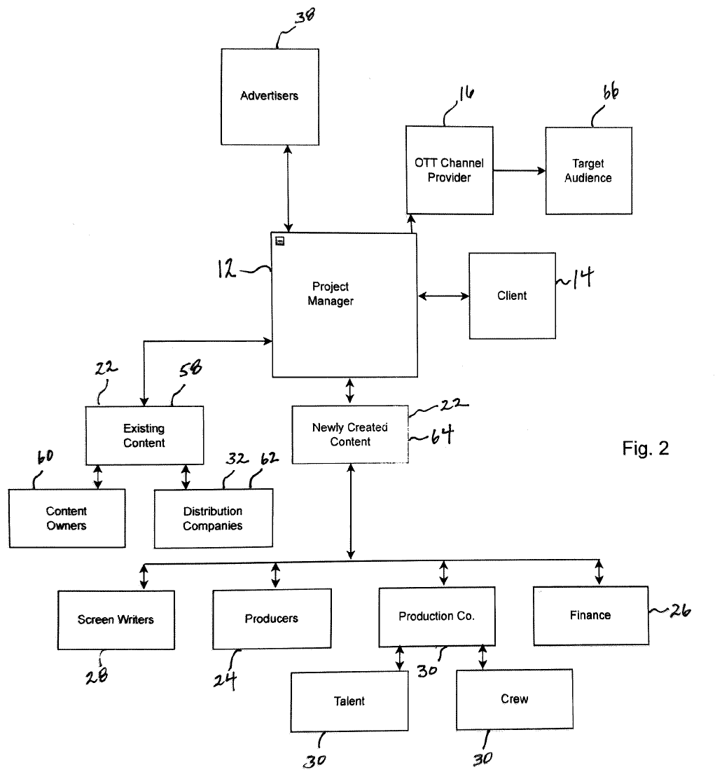

FIG. 2 is an additional schematic representation that shows other aspects of the content creator and content broadcaster of the eco system of the present invention.

At the center, is a project manager 12, who coordinates the creation and dissemination of the content 22. The project manager 12 works in a close communicative relationship with the client 14. As are most of the other relationships shown in FIG. 2, the relationship between the project manager 12 and the client 14 is a two-way relationship. For example, the project manager 12 and client work together to develop an overall strategy for the type, nature, and amount of content being produced.

Additionally, the client 14 is a source of content for the project manager 12. This client-sourced content can include content that has already been created, such as vintage basketball games, and prerecorded academic lectures, along with new productions that are created, such as student productions, new and currently existing sporting events and the like. Depending on the size and the nature of the university, it is likely that the university has a large supply of content that is potentially available to the project manager 12, for inclusion on the client's streaming channel.

In this regard, it should be noted that the university is likely to have two broad areas of content, including “non-contracted” content, and “contracted” content. Non-contracted content is content that the university has or creates, whose distribution and broadcast is not restricted by any contract with any third party. This differs from contracted content, such as basketball games and football game broadcasts. With most universities, broadcasting of sporting events is done pursuant to a contract between the university (or its athletic conference) and a television network, such as NBC, ABC, and ESPN.

The nature of this contractual relationship is often one where the particular contracting television network has an exclusive right to broadcast the basketball games and football games, which would therefore make the broadcast of such a basketball or football game over the streaming FAST channel of the client contrary to the terms of the contract. Additionally, the actual footage shot during the game may be the property of the broadcast network whose cameraman and announcers created the broadcast.

In such case, the university might likely have no right at any time to broadcast the basketball and football games over its streaming channel network. Nonetheless, it is possible that the university and project manager 12 would be able to secure a contractual arrangement with the broadcasting channel that would permit the basketball or football game to be broadcast over the streaming channel under certain conditions, such as by permitting it to be broadcast over the client's streaming channel during a time period that would commence after a certain time interval after the conclusion of the game.

As such, this client created content could be provided to the project manager 12, who, because of the nature of streaming services, would maintain copies of the broadcast within its server, for being accessed by viewers On Demand, in the way that one accesses programs on demand from other streaming services, such as Netflix, Amazon Prime, Hulu, and Paramount+.

Another source of content, is existing content 58 from persons other than the client. Such content is available from content owners 60, such as production companies that create the content, and also from distribution companies 62, that are hired to distribute content created by other parties. For example, should the university and project manager decide to broadcast a television show such as Wheel of Fortune, the project manager would contact CBS Media Ventures, the distributor who distributes and syndicates Wheel of Fortune television episodes.

Another source of content comprises newly created content 64.

Newly created content 64 usually involves the collaboration of a variety of sources and talents to create the content. In creating newly created content 64 for broadcast on the client's channel, the project manager 12, or its subsidiary, would likely interact with various elements such as screen writers 28, producers 24, finance persons 26, and production companies 30 whose components include both talent and crew components to create the desired television content.

Because of the collaborative nature of the creation of content, it is likely that the communication between the various collaborators would need to be a two-way communication, which is facilitated through the computer system and network of the present invention. Actually, a more accurate representation might be that of a web type communication schematic, where each of the collaborative persons involved in the creation of content, are talking, either alone, or in meetings to every other one of the collaborators.

Another input source comprises the advertisers 38. The advertisers 38 create advertising content such as commercials, which are then delivered to the project manager 12, for incorporation into the program. The output of the created content, including both the newly created content 64 and the existing content 58 is then transmitted via a global computer network to the OTT channel provider, who then provides a platform that can be accessed by the target audience 66 to view the content.

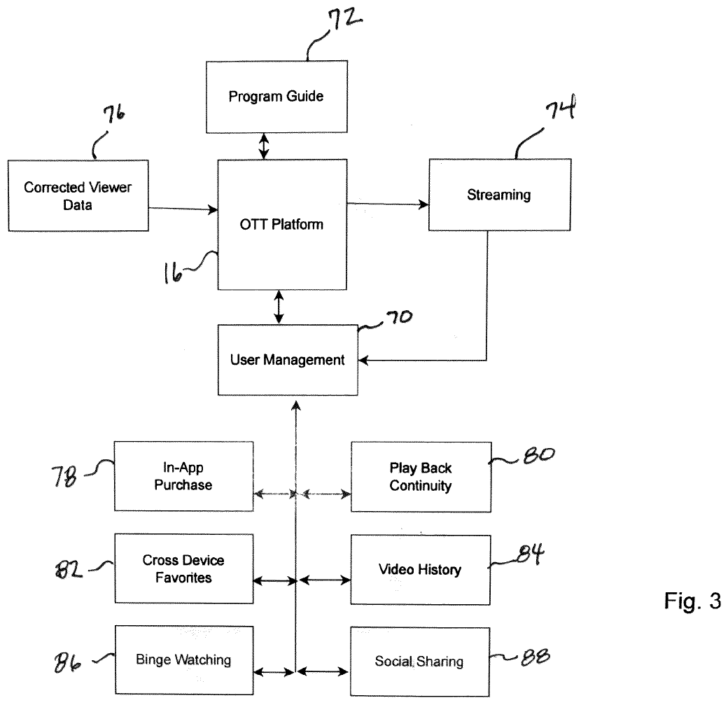

Turning now to FIG. 3, a schematic representation is shown of the relationship between the user and the OTT platform provider, that gives the user the ability to manipulate the programming that he sees on his television, so that the user can control the time and programming that he chooses to watch. This client created content could be provided to the project manager 12, who, because of the nature of streaming services, would maintain copies of the broadcast within its server, for being accessed by viewers On Demand, in the way that one accesses programs on demand from other streaming services, such as Netflix, Amazon Prime, Hulu, and Paramount+.

The central entity in this user management is the OTT platform 16. One can think of an OTT platform 16 as being similar to Netflix, insofar as the user interacts with the Netflix platform to select the movies and shows he desires to watch, and the timeframe in which he desires to watch them.

There exists a user management component 70, which includes onscreen content, and a device for manipulating the data on the OTT platform 16. The user management device 70 may comprise a remote control or operation buttons on a television set or can comprise a smart phone, a tablet or a general purpose computer.

Among the user management tools that exist is the software on the OTT platform 16, that enables the user to employ the remote control to navigate around the OTT platform site so that he or she can choose to stream the content that they wish. Additionally, the OTT platform 16 should include a program guide 72. For channels that are streaming live content, at 74, such as basketball games and football games, the program guide would include information about when the particular events are being broadcast over the streaming platform.

For On Demand uses, the program guide would likely appear to be a screen with its many programming selections, that the user could choose to stream On Demand, at whatever time he chooses, as opposed to a broadcast type live event, such as a football game, which can only be streamed during the time that the game is occurring, unless the game is saved and then becomes part of an On Demand streaming program.

The user management device 70 and software enables a user to make in app purchases 78 of programming, which would include both free programs that he chooses to stream, and paid content that he can select to stream after making a purchase of the program.

The user management tools 70 also include a mechanism for providing play back continuity 80, and a mechanism for communicating between devices, at 82, so that the user's favorites will appear on more than one device. The user management can also include a video history 84, and facilitate binge watching by the user, at 86, and social sharing, at 88.

Turning now to the OTT platform, that the output of the OTT platform is streamed programming, whether that streamed programming is On Demand programming or live programming. Additionally, another input into the OTT platform is collected viewer data. This collected viewer data can include things such as the history of the programs that the user has watched. There exists a plurality of data points that can be captured by the OTT platform. Among those that can be captured are the following:
a. Service Analytics: Understand the Performance of the Service.
   How many people are engaging with my Invention/Client's streaming channel platform
   What is the bounce rate from my player?
   What devices are being used to watch content?
b. Audience Analytics: Understand Who Customers Are and What They Do.
   What is the amount of daily/monthly active users (DAU/MAU)?
   How can we segment our user base (device, locations, in-app behaviors etc.)
   What are our most and least valuable customers?
c. Content Analytics: Understand How Content Is Performing.
   How many titles do my users watch per week?
   What is my top performing content?
   What is my least performing content?
d. Engagement Analytics: Understanding user-interaction.
   What is the typical user journey?
   What is the time that users spend on the app per session?
   What is the time before a user starts playing a video?

By reviewing the user's viewer history, the platform is capable of making suggestions as

what yet-to-be-seen program might be especially attractive to the viewer. Additionally, viewer data can be collected where necessary, to pay royalties to various content providers, or to provide content providers with data relating to the number of persons who have viewed their particular programs.

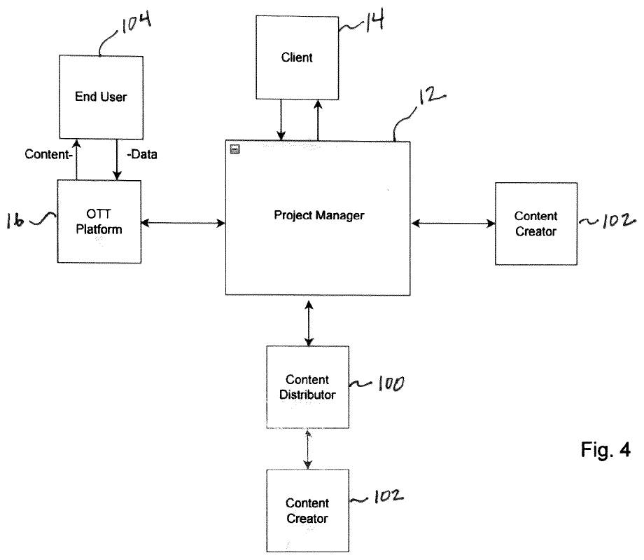

Your attention is now directed to FIG. 4, which is a more simplified view of the relationship between the various components of the present application. As will be appreciated, the various components are typically connected by the computer system which includes distributed computers and a global communication network such as the internet, which allows the distributor of computers to talk to each other.

Once again, the project manager 12 is at the center of the relationship scheme, as the project manager 12 is the person who is ultimately responsible for obtaining the content, interacting with the client 14, interacting with the OTT platform 16, and designing the systems.

The project manager 12 interacts with content distributors 100 and content creators 102 (directly and/or indirectly), who provide content to the project manager 12, for streaming. As discussed above, the content created can be either new content, or existing content.

Additionally, a large number of interactions occur between the project manager 12 and the client 14. As will be discussed in more detail below, this interaction includes the transfer of monies between the two entities, along with decisions that are made mutually, relating to content to broadcast, and establishing goals for the material and content being streamed, to best serve the client's mission and marketing goals.

Further, interaction between the client 14 and project manager 12 exists because much of the content that will be streamed will likely originate from the client 14. This will include event content, such as basketball games, theater performances, and concerts, along with non-event related material or content that may be produced by students or faculty in the television production department.

Such non-event content might include news programs and student productions, along with content provided by faculty and staff, such as lectures, professorial lectures, professorial help sessions, and other content that is created because someone at the university believes that the content is valuable both to create, and to broadcast. As shown in FIG. 4, some content is directly provided by the content creator 102 to the project manager 12 whereas other content is provided to a content distributor 100, who then provides it to the project manager 12.

Interaction occurs between the OTT platform 16 and project manager 12. The project manager 12 likely will have a large role in setting up the OTT platform 16, and keeping the OTT platform 16 fresh, such as by adding new programs as they become available, and removing some programming from the OTT platform 16 as it is no longer available.

Interaction will occur between the end user 104 and OTT platform 16, as described in connection with FIG. 3, where streaming content is transferred from the OTT platform 16 to the end user 104, and data about the user is transferred from the end user to the OTT platform, which eventually finds its way to the project manager 12 and likely the client 14.

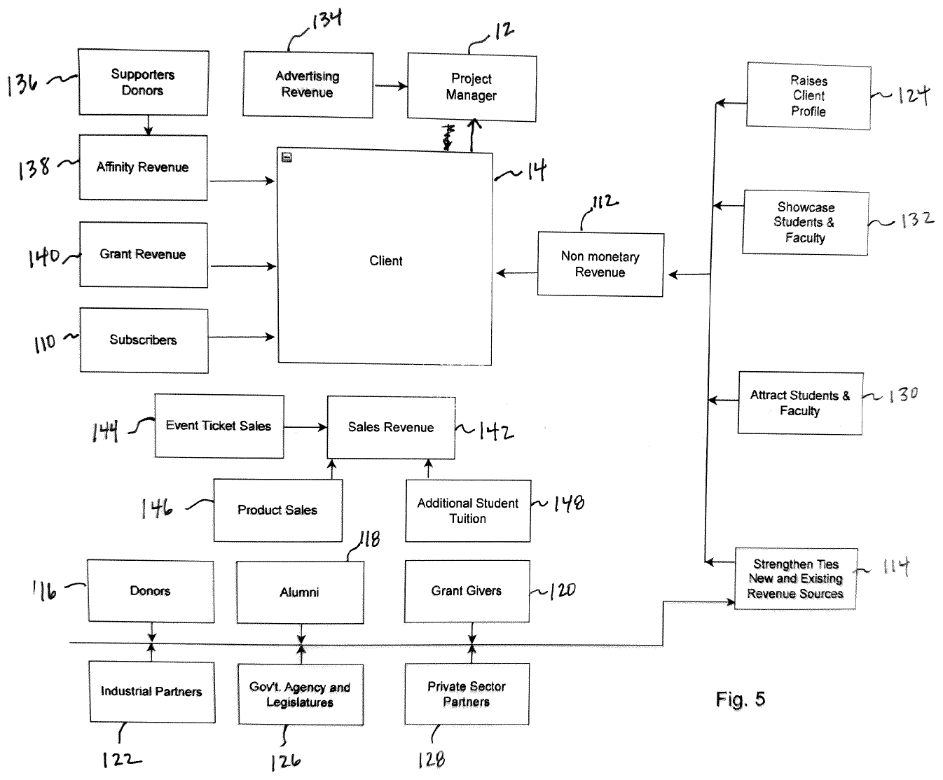

Your attention is now directed to FIG. 5. FIG. 5 is a schematic view of the financial relationships among the parties. Generally, FIG. 5 tends to show the revenue that is received by the client 14, as opposed to the revenue that is spent by the client.

There are generally two primary types of revenue that are shown in FIG. 5. One type of revenue is monetary revenue, which includes such things as the money that subscribers 110 pay to the be able to access the streaming data.

The other category of revenue to the client is non-monetary revenue 112. It is believed that the non-monetary revenue 112 may be as important to the client as the monetary revenues, and just as lucrative, although indirectly.

Broadcast and television programming about a university has been demonstrated to increase the indirect, non-monetary revenue that the university receives. For example, in 2010, Butler University's basketball team made it to the final game of the NCAA Division I tournament. Although Butler was a well-established university located in Indianapolis, it is a relatively small school and is not well known outside of academic circles and the Midwest.

The broadcast of Butler's team on the NCAA tournament program caused a several fold increase in the number of visits to Butler's website, substantially increased the number of applicants who applied to go to school at Butler, and increased Butler's regular season basketball ticket sales, resulting in an increase of alumni donations, and otherwise “put the school on the map”.

Turning first to the non-monetary revenue sources 112, one avenue that the programming serves is to strengthen ties with new and existing revenue sources 114. These revenue sources include such persons as donors 116 who may contribute money, alumni 118, grant givers 120, such as The National Science Foundation, and other foundations. An additional source of non-monetary revenue are industrial partners 122, who may choose to fund research projects at research universities, such as Purdue, Indiana University, and Stanford.

Additionally, raising the profile of the school 124 through the programming, has a positive effect on the number of grants that are likely to be awarded by government agencies, and the amount of funding that is likely to be given by legislatures 126. Further, increased funding can be expected in the long term from private sector partners 128, whose ties with the university are strengthened by the programming.

Another source of non-monetary revenue 112 is that it helps to attract students and faculty to the school 130. As mentioned in connection with Butler University, raising the profile of a university will attract additional student applicants, which will generally both result in the university receiving more tuition revenue, and also indirectly, being perceived as a more elite institution of higher learning, for the increase in applicants will likely cause the school to wind up with a matriculating class that has a higher average GPA.

Additionally, the school's acceptance rate will likely decrease, which once again helps to provide the illusion of the school being a more elite school, or at least a more selective school than the school would have been without the increased number of applicants. In addition to students, faculty are subject to the same influences, as faculty are more likely to be attracted to a university with a more enhanced reputation. Additionally, the increased profile of the university will help to attract potential faculty who will place the university on their particular radars to apply to the university where they might not have applied to the school had they not heard of it, and had its profile not been raised.

Another source of non-monetary revenue that the programming can achieve is showcasing the school's students and faculty 132. By showcasing the awards, actions, and studies of the students and faculty, additional students should be attracted to the school. For smaller schools, this showcasing can lead to students discovering that a particular university has a program of which they may not have been aware. For example, some small schools have engineering programs which are not as widely known and publicized as the engineering programs of larger, land grant colleges, such as Michigan State, Purdue, and the University of Illinois.

In general, the non-monetary revenue source 112 to the university is the indirect revenue streams discussed above that are increased by the programming raising the university's profile. In particular, the programming enables more people to hear about the university, and more people to learn about the university and its various programs. This additional notoriety helps to attract donors, students, and faculty, along with the monetary contributions that such donors, students, and faculty provide. Ultimately, this non-monetary revenue benefits the university.

Additionally, there are sources of monetary revenue for the client 14. These sources of monetary revenue include such things as the advertising revenue 134 that is paid by advertisers to advertise on the programming, and especially when the channel is broadcast in the FAST manner. FAST channel is advertiser supported, as are the commercial television networks, as opposed to being subscriber funded, such as cable networks, such as Netflix and Amazon Prime.

Another source of revenue are supporters and donors 136 who are inclined to donate more money to the school because they have been asked to do so in the programming, or because they have developed a stronger affinity for the institution. As used herein, these supporter and donor monies are referred to as affinity revenues 138, and include not only alumni type donors, but also other donors who have an affinity with the particular university, such as non-alumni fans of Notre Dame Football.

Another source of monetary revenue is grant revenue 140, that hopefully is increased by the programming, because the programming of the channel helped to raise the profile and the perceived excellence of the university. As mentioned above, additional revenue can be derived from a subscriber for a channel that is set up similar to Netflix or Amazon Prime, where you must be a subscriber to have access to the channel, or otherwise those who are on a “pay as you go” program where they purchase selected content from the site, such as sporting events that some users may choose to purchase on a “as watched and wanted” basis rather than to be a continuing subscriber.

A further source of monetary revenue can best be described as sales revenue 142, that the university receives for selling products and services. Although these products and services generate revenue for the university without the programming, the programming provided by the channel of the present invention helps to increase these sales revenue streams.

These sales revenue streams include event ticket sales 144, such as basketball tickets, football tickets, and the like. Another source of these sales are product sales 146 that include university-branded products such as university branded apparel, university branded coffee cups, blankets, glasses, keychains, plaques, and the like.

Finally, an additional source of sales revenue, is additional student tuition 148 that is received if additional students are attracted to the university who might otherwise not have been attracted to the university. For some state universities, even if they are at capacity, additional revenue can be achieved by admitting more foreign, out-of-state, and ROTC students who typically might pay more per credit hour than an in-state student. By attracting more students, and admitting more foreign and out-of-state students, the university can generate more revenue for the same number of students.

As is further shown in FIG. 5, money flows from the client 14 to the project manager 12, to compensate the project manager for the services that the project manager performs. The manner of payment of the compensation, the amount of compensation, and the timing of the compensation and payment would be governed by the contractual relationship between the parties.

The applicant believes that there is a significant advantage to the client 14 in having the revenue flow from the revenue sources directly to the client 12, with the client then paying money over to the project manager for fees and costs to which the project manager is contractually entitled. The benefit of this arrangement is that if the project manager 12 is a minority business enterprise, the money flowing to the project manager will help to increase the amount of minority business enterprise spending performed by the client 14, which, in certain circumstances, can help the client meet goals that are imposed by governments, agencies, charities and donors.

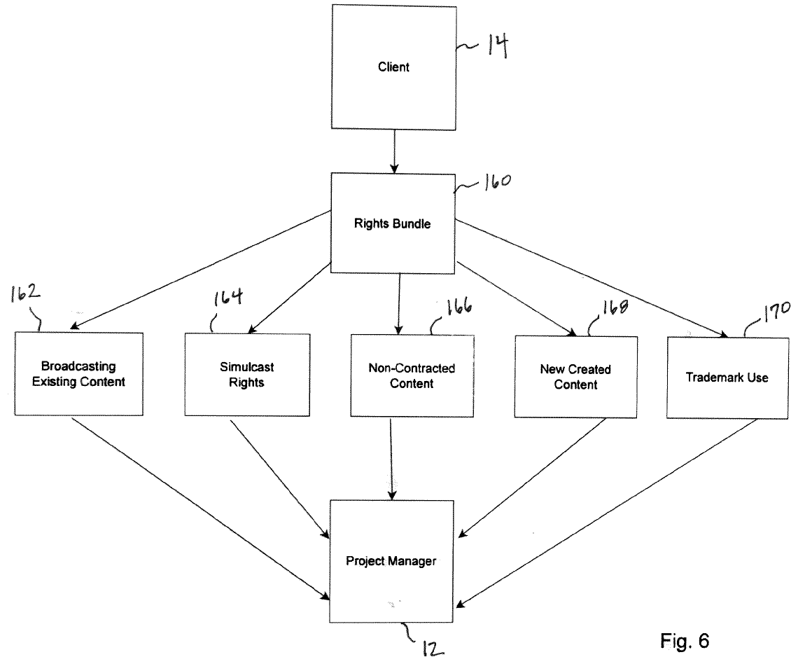

Your attention is next directed to FIG. 6. FIG. 6 is a schematic representation of the various rights that are transferred between the parties, and in particular, transferred among the project manager 12 and the client 14.

Initially, the client 14 will, by contract, grant a rights bundle 160 to the project manager to cover a variety of rights that the project manager 12 may wish to obtain. Among these might be the right to broadcast existing content 162. Another right might be simulcast rights 164. Simulcast rights 164 might exist where an event, such as a basketball game is broadcast on a commercial channel, such as ESPN, while simultaneously, the same basketball game is broadcast at the same time by the client's channel 18.

As one might imagine, this requires a contractual agreement between the project manager, OTT provider, the university, and the broadcaster. As an alternative to simulcast rights, there might exist delay broadcast rights. For example, the university's channel 18 may have the right to make the game available via streaming on the day after, or at some time period after the live event has occurred which has been broadcast on the commercial channel, such as ABC or CBS.

Preferably, the university would give its project manager 12 created channel an exclusive right for non-contracted content 166. Non-contracted content 166 is content that for which no broadcast rights have been given to a third party. For example, ESPN may have a contract right with the university, or its conference, to broadcast the university's basketball games.

However, although the basketball games are contracted content, broadcasts of lesser-known sports, such as wrestling, gymnastics, and lacrosse may not be contracted to any commercial provider. In that case, the project manager 12 and ultimately the university's channel 18 should have the exclusive right to broadcast both when the event is occurring, and then be able to warehouse the non-contracted content so that it can be accessed later via an On Demand request from a user.

Another rights bundle might include the right to make new created content 168. As will be appreciated, it is likely that much of the content that is created for the university, will involve university personnel, university locations, university facilities and the like. Preferably, the rights bundle 160 would give the project manager 12 the right to create such content, without having to negotiate with the university for the rights and permissions to use such university owned intellectual property.

A final bundle would include a non-exclusive right to use the trademarks of the university. For example, the trademark might be used by the streaming channel generally, as the channel might be named the “state university” streaming channel, and thereby use the name and logo of the hypothetical state university.

Additionally, a streaming channel that focuses on subject matter that revolves around the university is likely to be affiliated in the minds of the public with the university. For the reasons set forth above, the channel will have an impact on the brand recognition of the university, and the perception and good will of the university.

For those reasons, a trademark license 170 should be granted to the project manager to ensure that they can use the trademarks, and for the university to ensure that the university branded and university associated material that is being broadcast does not reflect poorly on the university, and otherwise, meets the university's quality control standards.

Having described the invention in detail with reference to certain preferred embodiments, it will be appreciated that variation and modification can exist within the scope and spirit of the present invention, as defined by the claim below, and their equivalents.

What is claimed is:

1. A method for managing a customized television streaming service using a computer system including one or more computers connected with each other through a global communication network, wherein a project manager and a client each include a computer system, the method including:
tasking the project manager with creating a streaming channel for the client;
receiving content from the client at the project manager for streaming to an end viewer;
receiving content from at least one content provider other than the client at the project manager for streaming to the end viewer; and
channeling the content from the client and the at least one content provider other than the client to a digital distribution service for streaming to the end viewer.

2. The method of claim 1, wherein the project manager is in electronic communication with a finance provider, the content provider, an advertising provider and an editor.

3. The method of claim 1, wherein the streaming channel includes an over-the-top (OTT) platform for delivering streamed content over the global computer network.

4. The method of claim 1, wherein the client is an educational enterprise.

5. The method of claim 1, wherein the content is delivered to the end viewer via at least one of Free Advertising Supported Television (FAST), Authenticated Video On Demand (AUTHVOD), Advertising-Based Video On Demand (AVOD), Subscription Video On Demand (SVOD), and Transactional Video On Demand (TVOD).

6. The method of claim 1, wherein the project manager performs analytics to identify top performing content and least performing content.

7. The method of claim 1, wherein the project manager performs analytics to identify an amount of daily users and monthly users.

8. The method of claim 1, wherein the end viewer must subscribe and purchase the streaming channel to view.

9. The method of claim 1, further including transferring a bundle of rights from the client to the project manager.

10. The method of claim 9, wherein the bundle of rights includes intellectual property rights.
